(19) United States
(12) Patent Application Publication
(10) Pub. No.: US 2017/0090085 A1
(43) Pub. Date: Mar. 30, 2017

(54) POLARIZER, POLARIZING PLATE, AND IMAGE DISPLAY APPARATUS

(71) Applicant: NITTO DENKO CORPORATION, Osaka (JP)

(72) Inventors: Shusaku Goto, Ibaraki-shi (JP); Masahiro Yaegashi, Ibaraki-shi (JP)

(73) Assignee: NITTO DENKO CORPORATION, Osaka (JP)

(21) Appl. No.: 15/271,949

(22) Filed: Sep. 21, 2016

(30) Foreign Application Priority Data
Sep. 28, 2015 (JP) 2015-190081

(51) Int. Cl. G02B 5/30; B29D 11/00; C08J 7/04; C09D 5/29; C09D 131/04

(52) U.S. Cl. CPC G02B 5/305; C09D 5/29; C09D 131/04; C08J 7/04; B29D 11/00644; B29D 11/00894; C08J 2331/04; B29K 2105/0032

(57) ABSTRACT

There is provided a polarizer that can realize multi-functionalization and high-functionalization of an electronic device, such as an image display apparatus. A polarizer according to an embodiment of the present invention includes a resin film containing iodine, wherein the polarizer has formed therein a transparent portion having a transmittance higher than that of another portion, and the transparent portion has a single hue (a²+b²)^{1/2} of less than 1.0, where the a represents an a value of an Lab colorimetric system and the b represents a b value of the Lab colorimetric system.

### BACKGROUND OF THE INVENTION

This application claims priority under 35 U.S.C. Section 119 to Japanese Patent Application No. 2015-190081 filed on Sep. 28, 2015 which is herein incorporated by reference.

1. Field of the Invention

The present invention relates to a polarizer, a polarizing plate, and an image display apparatus.

2. Description of the Related Art

Some of the image display apparatus of a cellular phone, a notebook personal computer (PC), and the like have mounted thereon internal electronic parts, such as a camera. Various investigations have been made for the purpose of improving, for example, the camera performance of any such image display apparatus (for example, Japanese Patent Application Laid-open No. 2011-81315, Japanese Patent Application Laid-open No. 2007-241314, US 2004/0212555, Japanese Patent Application Laid-open No. 2012-137738, and WO 2015/046969 A). However, an additional improvement in camera performance or the like has been desired in association with rapid widespread use of a smart phone and a touch panel-type information processing apparatus. In addition, a polarizer partially having a non-polarization portion has been required in order to correspond to the diversification of the shapes of the image display apparatus and the high-functionalization thereof.

The non-polarization portion is typically formed by subjecting the polarizer to drilling processing, but there arises a problem, such as the occurrence of a crack in the polarizer at the time of the processing. In view of the foregoing, the following has been proposed (Japanese Patent Application Laid-open No. 2014-211548). After a laminated film obtained by forming a polyvinyl alcohol-based resin layer on the surface of a resin substrate film has been stretched, a region that does not show any polarizing ability (non-polarization region) is formed by forming an anti-dyeing layer on the surface of the polyvinyl alcohol-based resin layer, and dyeing the resultant with a dichromatic pigment. In addition, the formation of the non-polarization region through the irradiation of a polarizer with light having a specific wavelength has been proposed (WO 2015/046969 A).

However, a further improvement of the non-polarization region has been desired for sufficiently corresponding to the multi-functionalization and the high-functionalization.

### SUMMARY OF THE INVENTION

The present invention has been made to solve the above-mentioned problems, and a primary object of the present invention is to provide a polarizer that can realize the multi-functionalization and high-functionalization of an electronic device, such as an image display apparatus.

A polarizer according to an embodiment of the present invention includes a resin film containing iodine, wherein the polarizer has formed therein a transparent portion having a transmittance higher than that of another portion, and the transparent portion has a single hue (a²+b²)^{1/2} of less than 1.0, where the a represents an a value of an Lab colorimetric system and the b represents a b value of the Lab colorimetric system.

In one embodiment of the present invention, the transparent portion has an iodine content of 1.0 wt % or less.

In one embodiment of the present invention, the transparent portion has a content of at least one of an alkali metal and an alkaline earth metal of 0.5 wt % or less.

In one embodiment of the present invention, the resin film has a thickness of 8 μm or less.

In one embodiment of the present invention, optical characteristics in the another portion satisfy relationships of P>-(10^{0.929T-42.4}−1)×100, provided that T<42.3, and P≧99.9, provided that T≧42.3, where P represents a polarization degree (%) and T represents a single axis transmittance (%).

In one embodiment of the present invention, the transparent portion corresponds to a camera portion of an image display apparatus on which the polarizer is mounted.

According to another aspect of the present invention, there is provided a method of producing the polarizer as described above. The method includes decolorizing a desired portion of a resin film containing a dichromatic substance.

In one embodiment of the present invention, the decolorizing is performed by bringing a basic solution into contact with the resin film containing the dichromatic substance.

In one embodiment of the present invention, the method further includes bringing an acidic solution into contact with a portion of the resin film with which the basic solution has been brought into contact.

In one embodiment of the present invention, at a time of the contact of the basic solution, a surface of the resin film is covered with a surface protective film so that at least part of the surface of the resin film may be exposed.

In one embodiment of the present invention, the resin film containing the dichromatic substance is produced by a method including dyeing a resin film with the dichromatic substance, and subjecting the resin film to underwater stretching.

According to still another aspect of the present invention, there is provided a polarizing plate. The polarizing plate includes the above described polarizer having formed therein the transparent portion.

In one embodiment of the present invention, the polarizing plate has a shape corresponding to an image display apparatus on which the polarizing plate is mounted, and the transparent portion is formed to be spaced apart from an end side.

According to still another aspect of the present invention, there is provided an image display apparatus. The image display apparatus the above-described polarizing plate.

According to an embodiment of the present invention, there is provided a polarizer that can achieve the multi-functionalization and high-functionalization of an electronic device.

### BRIEF DESCRIPTION OF THE DRAWINGS

FIG. 1 is a plan view of a polarizer according to one embodiment of the present invention.

### DETAILED DESCRIPTION OF THE PREFERRED EMBODIMENTS

Embodiments of the present invention are described below.

However, the present invention is not limited to these embodiments.

### A. Polarizer

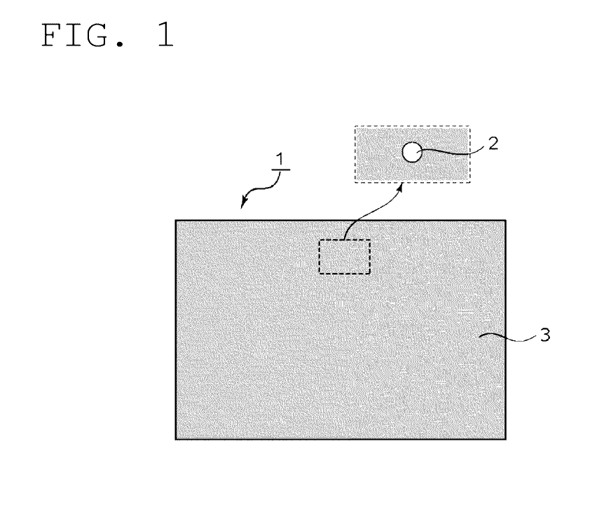

FIG. 1 is a plan view of a polarizer according to one embodiment of the present invention. A polarizer 1 includes a resin film containing a dichromatic substance. The polarizer (resin film) 1 has formed therein a transparent portion 2 having a relatively high transmittance. Specifically, the polarizer 1 has formed therein the transparent portion 2 having a transmittance higher than that of another portion 3. The transparent portion can function as a non-polarizing portion. With such construction, a problem in terms of quality, such as cracking, delamination, or adhesive protrusion, is avoided as compared to the case where a through-hole as a non-polarizing portion is formed mechanically (e.g., by a method involving mechanically punching out the through-hole in the polarizer through the use of, for example, chisel punching, a plotter, or a water jet).

In the illustrated example, the transparent portion 2 having a small circular shape is formed in the central portion of the upper end portion of the polarizer 1, but the number, arrangement, shapes, sizes, and the like of the transparent portions can be appropriately designed. The numbers and the like are designed in accordance with, for example, the position, shape, and size of the camera portion of an image display apparatus on which the polarizer is mounted. In this case, the transparent portion preferably has a substantially circular shape having a diameter of 10 mm or less.

The transmittance of the transparent portion (e.g., a transmittance measured with light having a wavelength of 550 nm at 23° C.) is preferably 50% or more, more preferably 60% or more, still more preferably 75% or more, particularly preferably 90% or more. With such transmittance, when the transparent portion is caused to correspond to, for example, the camera portion of an image display apparatus, an adverse effect on the photographing performance of its camera can be prevented.

The transparent portion has a single hue (a²+b²)^{1/2} of less than 1.0, preferably 0.7 or less, more preferably 0.5 or less. When the polarizer has such transparent portion extremely close to a neutral color, an image display apparatus extremely excellent in, for example, photographing performance of a camera can be obtained. Here, a represents an a value of an Lab colorimetric system and b represents a b value of the Lab colorimetric system. The absolute value of the single a value of the transparent portion is preferably 1.0 or less, more preferably 0.5 or less, most preferably zero. The absolute value of the single b value of the transparent portion is preferably 1.0 or less, more preferably 0.5 or less, most preferably zero.

The transparent portion is preferably a portion having a content of the dichromatic substance lower than that of the another portion. The content of the dichromatic substance of the transparent portion is preferably 1.0 wt % or less, more preferably 0.5 wt % or less, still more preferably 0.2 wt % or less. Meanwhile, a lower limit for the content of the dichromatic substance of the transparent portion is typically equal to or less than a detection limit. A difference between the content of the dichromatic substance in the another portion and the content of the dichromatic substance in the transparent portion is preferably 0.5 wt % or more, more preferably 1 wt % or more. When iodine is used as the dichromatic substance, the iodine content of the transparent portion is determined from, for example, a calibration curve produced in advance from an X-ray intensity measured by fluorescent X-ray analysis through the use of a standard sample.

The polarizer (except the transparent portion) preferably exhibits absorption dichroism at any wavelength in the wavelength range of from 380 nm to 780 nm. The polarizer (except the transparent portion) has a single axis transmittance of preferably 40.0% or more, more preferably 41.0% or more, still more preferably 42.0% or more, particularly preferably 43.0% or more. Meanwhile, a theoretical upper limit for the single axis transmittance of the polarizer (except the transparent portion) is 50%, and a practical upper limit there for is 46%. The polarization degree of the polarizer (except the transparent portion) is preferably 99.8% or more, more preferably 99.9% or more, still more preferably 99.95% or more. The polarization degree (P) and the single axis transmittance (T) preferably satisfy relationships of P>-(10^{0.929T-42.4}−1)×100 (provided that T<42.3) and P≧99.9 (provided that T≧42.3).

The thickness of the polarizer (resin film) is, for example, 10 μm or less, preferably 8 μm or less, more preferably 5 μm or less. As the thickness becomes smaller, the (a²+b²)^{1/2} can be lower. Further, the adoption of such thickness can result in the formation of a transparent portion excellent in surface smoothness. In addition, in contact with a basic solution to be described later, the transparent portion is formed in a short time period. Further, the thickness of a portion with which the basic solution is brought into contact may be thinner than the other portion, but when the thickness of the polarizer is small, a difference in thickness between the portion brought into contact with the basic solution and the other portion can be reduced. Meanwhile, the thickness of the polarizer is preferably 1.0 μm or more, more preferably 2.0 μm or more.

Examples of the dichromatic substance include iodine and an organic dye. The substances may be used alone or in combination. Of those, iodine is preferably used. The use of iodine can result in satisfactory formation of the transparent portion.

Any appropriate resin may be used as a resin for forming the resin film. A polyvinyl alcohol-based resin (hereinafter referred to as “PVA-based resin”) is preferably used as the resin. Examples of the PVA-based resin include polyvinyl alcohol and an ethylene-vinyl alcohol copolymer. The polyvinyl alcohol is obtained by saponifying polyvinyl acetate. The ethylene-vinyl alcohol copolymer is obtained by saponifying an ethylene-vinyl acetate copolymer. The saponification degree of the PVA-based resin is typically from 85 mol % to 100 mol %, preferably 95.0 mol % or more, more preferably 99.0 mol % or more, particularly preferably 99.93 mol % or more. The saponification degree may be determined in conformity with JIS K 6726-1994. The use of the PVA-based resin having such saponification degree can provide a polarizer excellent in durability.

The average polymerization degree of the PVA-based resin may be appropriately selected depending on purposes. The average polymerization degree is typically from 1,000 to 10,000, preferably from 1,200 to 6,000, more preferably from 2,000 to 5,000. The average polymerization degree may be determined in conformity with JIS K 6726-1994.

B. Method of producing Polarizer A method involving decolorizing a desired portion of a resin film containing a dichromatic substance is preferably adopted as a method of producing the polarizer. Such method has an extremely high degree of freedom in design in terms of, for example, the site at which the transparent portion is formed, and the size and shape of the transparent portion.

### B-1. Resin Film Containing Dichromatic Substance

The resin film containing the dichromatic substance can be typically obtained by subjecting a resin film (a resin layer formed on a substrate is also permitted) to any one of various treatments, such as a dyeing treatment, a stretching treatment, a swelling treatment, a cross-linking treatment, a washing treatment, and a drying treatment. The number of times, order, timing, and the like of the treatments may be appropriately set.

The thickness of the substrate is preferably from 20 μm to 300 μm, more preferably from 50 μm to 200 μm. As the materials for forming the substrate, there are given, for example, an ester-based resin, such as a polyethylene terephthalate-based resin, a cycloolefin-based resin, an olefin-based resin, such as polypropylene, a (meth)acrylic resin, a polyamide-based resin, a polycarbonate-based resin, and a copolymer resin thereof. Of those, a polyethylene terephthalate-based resin is preferably used. In particular, an amorphous polyethylene terephthalate-based resin is preferably used. Specific examples of the amorphous polyethylene terephthalate-based resin include: a copolymer further containing isophthalic acid as a dicarboxylic acid component; and a copolymer further containing cyclohexanedimethanol as a glycol component. The substrate, as it is, can be utilized as a protective film.

The thickness of the resin layer is preferably from 3 μm to 40 μm, more preferably from 3 μm to 20 μm, still more preferably from 3 μm to 15 μm. The resin layer is, for example, an applied layer formed by applying an application liquid containing the PVA-based resin onto the substrate, and drying the liquid. The application liquid is typically a solution prepared by dissolving the PVA-based resin in a solvent. Water is preferably used as the solvent. The PVA-based resin concentration of the solution is preferably from 3 parts by weight to 20 parts by weight with respect to 100 parts by weight of the solvent. The saponification degree of the PVA-based resin in the application liquid is preferably 99.5 mol % or less. This is because film formability on the substrate can be sufficiently secured.

The dyeing treatment is typically performed by using a dyeing liquid containing a dichromatic substance. When iodine is used as the dichromatic substance, the dyeing liquid is preferably an aqueous solution of iodine. The compounding amount of iodine is preferably from 0.05 part by weight to 0.5 part by weight with respect to 100 parts by weight of water. The aqueous solution of iodine is preferably compounded with an iodide (e.g., potassium iodide) in order that the solubility of iodine in water may be increased. The compounding amount of the iodide is preferably from 0.1 part by weight to 20 parts by weight, more preferably from 0.5 part by weight to 10 parts by weight with respect to 100 parts by weight of water.

The resin film is typically dyed by being immersed in the dyeing liquid. The liquid temperature of the dyeing liquid is preferably from 20° C. to 50° C. An immersion time is preferably from 5 seconds to 5 minutes. The dyeing conditions (the concentration, the liquid temperature, and the immersion time) may be set so that the polarization degree or single axis transmittance of the polarizer to be finally obtained may fall within a predetermined range.

The stretching modes of the stretching treatment are roughly classified into, for example, an in-air stretching mode and an underwater stretching mode, but the resin film (laminate of the substrate and the resin layer) is preferably subjected to underwater stretching at least once. The adoption of the underwater stretching can provide a transparent portion extremely close to a neutral color. Specifically, according to the underwater stretching, the resin film can be stretched at a temperature lower than its glass transition temperature (typically about 80° C.), and hence the resin film can be stretched at a high ratio while its crystallization is suppressed. As a result, excellent optical characteristics can be obtained while coloring due to the modification of the resin film (e.g., the transformation of the polyvinyl alcohol-based resin into a polyene) is suppressed. The coloring due to the modification of the resin film can be clearly observed in the transparent portion.

The liquid temperature of a stretching bath in the underwater stretching mode is preferably from 40° C. to 85° C., more preferably from 50° C. to 85° C. The time period for which the resin film (laminate) is immersed in the stretching bath is preferably from 15 seconds to 5 minutes. The stretching ratio of the resin film (laminate) by the underwater stretching is preferably 2.0 times or more. Any appropriate method may be adopted as a stretching method. The stretching may be performed in one stage, or may be performed in a plurality of stages. The underwater stretching can be combined with the in-air stretching to the extent that the modification of the resin film can be suppressed. A stretching ratio by the in-air stretching is preferably 3.0 times or less. The stretching temperature of the in-air stretching is preferably from 100° C. to 180° C., more preferably from 120° C. to 160° C. The resin film (laminate) is finally stretched at a stretching ratio of preferably 4.0 times or more, more preferably 5.0 times or more with respect to its original length.

The underwater stretching may be performed by immersing the resin film (laminate of the substrate and the resin layer) in an aqueous solution of boric acid. The aqueous solution of boric acid is preferably obtained by dissolving boric acid and/or a borate in water serving as a solvent. The concentration of boric acid is preferably from 1 part by weight to 10 parts by weight with respect to 100 parts by weight of water. When the concentration of boric acid is set to 1 part by weight or more, the dissolution of the resin layer can be effectively suppressed.

The aqueous solution of boric acid may be compounded with an iodide. This is because the elution of iodine can be suppressed when the resin film is dyed in advance. The concentration of the iodide is preferably from 0.05 part by weight to 15 parts by weight, more preferably from 0.5 part by weight to 8 parts by weight with respect to 100 parts by weight of water.

In one embodiment, the resin film containing the dichromatic substance is produced by a method including dyeing a resin film and subjecting the resin film (laminate) to the underwater stretching after the dyeing. When the underwater stretching is performed after the dyeing, the film can be more excellent in stretchability. As a result, a polarizer excellent in optical characteristics can be obtained.

### B-2. Decolorization

A method involving bringing a basic solution into contact with the resin film containing the dichromatic substance is preferably adopted as a method for the decolorization. When iodine is used as the dichromatic substance, the contact of the basic solution with a desired portion of the resin film can easily reduce the iodine content of the contact portion. Specifically, the contact can cause the basic solution to permeate into the resin film. An iodine complex in the resin film is reduced by a base in the basic solution to become an iodine ion. The reduction of the iodine complex to the iodine ion can increase the transmittance of the contact portion. Then, iodine that has become the iodine ion moves from the resin film into the basic solution. Thus, a transparent portion extremely close to a neutral color can be obtained. Specifically, for example, when the decolorization is performed by breaking the iodine complex through irradiation with laser light, iodine remains in the resin film and hence a tint remains in the formed transparent portion, but when the iodine content is reduced, such problem is prevented. Iodine remaining in the resin film forms an iodine complex again in association with the use of the polarizer, and hence the transmittance of the transparent portion may degrade.

Any appropriate method may be adopted as a method of bringing the basic solution into contact with the resin film. Examples thereof include: a method involving dropping, applying, or spraying the basic solution onto the resin film; and a method involving immersing the resin film in the basic solution. Upon contact of the basic solution, the resin film may be protected with any appropriate means (such as a protective film or a surface protective film) so that the basic solution may be prevented from being brought into contact with a portion except the desired portion (so that the concentration of the dichromatic substance may not reduce).

Any appropriate basic compound may be used as a basic compound in the basic solution. Examples of the basic compound include: hydroxides of alkali metals, such as sodium hydroxide, potassium hydroxide, and lithium hydroxide; hydroxides of alkaline earth metals, such as calcium hydroxide; inorganic alkali metal salts, such as sodium carbonate; organic alkali metal salts, such as sodium acetate; and ammonia water. Of those, hydroxides of alkali metals and/or alkaline earth metals are preferred, sodium hydroxide, potassium hydroxide, and lithium hydroxide are more preferred, and sodium hydroxide is particularly preferred. This is because the iodine complex can be efficiently ionized, and hence the transparent portion can be formed with additional ease. Those basic compounds may be used alone or in combination.

Any appropriate solvent may be used as the solvent of the basic solution. Specific examples thereof include: water; alcohols, such as ethanol and methanol; ethers; benzene; chloroform; and a mixed solvent thereof. Of those, water or an alcohol is preferably used because the iodine ion can satisfactorily migrate to the solvent.

The concentration of the basic solution is, for example, from 0.01 N to 5 N, preferably from 0.05 N to 3 N, more preferably from 0.1 N to 2.5 N. When the concentration of the basic solution falls within such range, the transparent portion can be efficiently formed. When the basic solution is an aqueous solution of sodium hydroxide, the concentration is preferably 1.0 wt % or more, more preferably from 2 wt % to 8 wt %.

The liquid temperature of the basic solution is, for example, 20° C. or more, preferably from 25° C. to 50° C. When the basic solution is brought into contact with the resin film at such temperature, the transparent portion can be efficiently formed.

The time period for which the basic solution is brought into contact with the resin film is set in accordance with, for example, the thickness of the resin film, and the kind and concentration of the basic compound in the basic solution. The contact time is, for example, from 5 seconds to 30 minutes, preferably from 5 seconds to 5 minutes.

As described above, upon contact of the basic solution, the resin film may be protected so that the basic solution may be prevented from being brought into contact with a portion except the desired portion. The protective film, as it is, can be utilized as a protective film for the polarizer. The surface protective film is temporarily used at the time of the production of the polarizer. The surface protective film is typically bonded to the resin film through intermediation of a pressure-sensitive adhesive layer because the surface protective film is removed from the polarizer at any appropriate timing.

In one embodiment, at the time of the contact of the basic solution, the surface of the resin film is covered with a surface protective film so that at least part of the surface of the resin film may be exposed. The polarizer of the illustrated example is produced by, for example, bonding a surface protective film having formed therein a through-hole having a small circular shape to the resin film containing the dichromatic substance, and bringing the basic solution into contact with the resultant. At that time, the other side of the resin film (the side on which the surface protective film is not arranged) is also preferably protected.

### B-3. Others

In one embodiment, the basic solution is removed from the resin film by any appropriate means after its contact with the resin film. According to such embodiment, for example, a reduction in transmittance of the transparent portion in association with the use of the polarizer can be prevented with additional reliability. A method of removing the basic solution is specifically, for example, washing, removal by wiping with waste cloth or the like, suction removal, natural drying, heat drying, blow drying, or drying under reduced pressure. The basic solution is preferably washed off. A washing liquid to be used in the washing is, for example, water (pure water), an alcohol, such as methanol or ethanol, or a mixed solvent thereof. Of those, water is preferably used. The number of times of the washing is not particularly limited, and the washing may be performed a plurality of times. When the basic solution is removed by drying, the temperature at which the solution is dried is, for example, from 20° C. to 100° C.

It is preferred that after the contact with the basic solution, the content of an alkali metal and/or an alkaline earth metal in the resin film be reduced in a contact portion with which the basic solution has been brought into contact. The reduction in content of the alkali metal and/or the alkaline earth metal can provide a transparent portion excellent in dimensional stability. Specifically, the shape of the transparent portion formed by the contact with the basic solution can be maintained as it is even under a humidified environment.

When the basic solution is brought into contact with the resin film, a hydroxide of the alkali metal and/or the alkaline earth metal may remain in the contact portion. In addition, when the basic solution is brought into contact with the resin film, a metal salt (e.g., a borate) of the alkali metal and/or the alkaline earth metal may be produced in the contact portion. Any such hydroxide or metal salt may produce a hydroxide ion, and the produced hydroxide ion may act on (decompose or reduce) the dichromatic substance (e.g., an iodine complex) present around the contact portion to expand a non-polarization region (transparent region). Therefore, it is assumed that the reduction in content of the alkali metal salt and/or the alkaline earth metal salt suppresses temporal expansion of the non-polarization region and hence enables the maintenance of a desired shape of the non-polarization portion.

The content of the alkali metal and/or the alkaline earth metal in the transparent portion is preferably 3.6 wt % or less, more preferably 2.5 wt % or less, still more preferably 1.0 wt % or less, particularly preferably 0.5 wt % or less. The content of the alkali metal and/or the alkaline earth metal can be determined from, for example, a calibration curve produced in advance from an X-ray intensity measured by fluorescent X-ray analysis through the use of a standard sample.

A method involving bringing an acidic solution into contact with the contact portion with the basic solution is preferably used as a method for the reduction. According to such method, the alkali metal and/or the alkaline earth metal is efficiently caused to migrate toward the acidic solution, and hence the content thereof can be reduced. The contact with the acidic solution may be performed after the removal of the basic solution, or may be performed without the removal of the basic solution.

Any appropriate acidic compound may be used as an acidic compound in the acidic solution. Examples of the acidic compound include: inorganic acids, such as hydrochloric acid, sulfuric acid, nitric acid, and hydrogen fluoride; and organic acids, such as formic acid, oxalic acid, citric acid, acetic acid, and benzoic acid. Of those, an inorganic acid is preferred as the acidic compound in the acidic solution, and hydrochloric acid, sulfuric acid, or nitric acid is more preferred. Those acidic compounds may be used alone or in combination.

Any one of the solvents listed as the examples of the solvent of the basic solution may be used as the solvent of the acidic solution. The concentration of the acidic solution is, for example, from 0.01 N to 5 N, preferably from 0.05 N to 3 N, more preferably from 0.1 N to 2.5 N.

The liquid temperature of the acidic solution is, for example, from 20° C. to 50° C. The time period for which the acidic solution is brought into contact with the portion is, for example, from 5 seconds to 5 minutes. The same method as the method of bringing the basic solution into contact with the resin film can be adopted as a method of bringing the acidic solution into contact with the portion. In addition, the acidic solution can be removed from the resin film. The same method as the method of removing the basic solution can be adopted as a method of removing the acidic solution.

### C. Polarizing Plate

A polarizing plate of the present invention includes the above-described polarizer. The polarizing plate typically includes the polarizer and a protective film arranged on at least one side of the polarizer. As the materials for forming the protective film, there are given, for example, a cellulose-based resin, such as diacetyl cellulose or triacetyl cellulose, a (meth)acrylic resin, a cycloolefin-based resin, an olefin-based resin, such as polypropylene, an ester-based resin, such as a polyethylene terephthalate-based resin, a polyamide-based resin, a polycarbonate-based resin, and copolymer resins thereof.

The surface of the protective film on which the polarizer is not laminated may have formed thereon a hard coat layer, or may be subjected to an antireflection treatment or a treatment intended for diffusion or for glare prevention. Such layer or treated surface may serve as a surface-treated layer. The surface-treated layer is preferably, for example, a layer having a low moisture permeability for the purpose of improving the humidification durability of the polarizer. A hard coat treatment is performed for the purpose of, for example, preventing the surface of the polarizing plate from being flawed. The hard coat layer can be formed by, for example, a system involving adding, to the surface, a cured coating film based on an appropriate UV-curable resin, such as an acrylic UV-curable resin or a silicone-based UV-curable resin, the cured coating film being excellent in hardness, sliding characteristic, and the like. The hard coat layer preferably has a pencil hardness of 2H or more. The antireflection treatment is performed for the purpose of preventing the reflection of ambient light on the surface of the polarizing plate, and can be achieved by the formation of a low-reflection layer of a type in conformity with a conventional one, such as a thin-layer type disclosed in Japanese Patent Application Laid-open No. 2005-248173 that prevents the reflection through the utilization of a reflected light-canceling effect exhibited by an optical interferential action or a structure type disclosed in Japanese Patent Application Laid-open No. 2011-2759 that provides the surface with a fine structure to express a low reflectance. An antiglare treatment is performed for the purpose of, for example, preventing the inhibition of the viewing of light transmitted through the polarizing plate due to the reflection of the ambient light on the surface of the polarizing plate, and is performed by, for example, providing the surface of the protective film with a fine uneven structure according to an appropriate system, such as a surface-roughening system based on a sandblast system or an embossing system, or a system involving compounding transparent fine particles. An antiglare layer may also serve as a diffusion layer (e.g., a viewing angle-broadening function) for diffusing the light transmitted through the polarizing plate to broaden a viewing angle or the like.

The thickness of the protective film is preferably from 10 μm to 100 μm. The protective film is typically laminated on the polarizer through intermediation of an adhesion layer (specifically an adhesive layer or a pressure-sensitive adhesive layer). The adhesive layer is typically formed of a PVA-based adhesive or an active energy ray-curable adhesive. The pressure-sensitive adhesive layer is typically formed of an acrylic pressure-sensitive adhesive.

### D. Image Display Apparatus

An image display apparatus of the present invention includes the above-described polarizing plate. Examples of the image display apparatus include a liquid crystal display apparatus and an organic EL device. Specifically, the liquid crystal display apparatus includes a liquid crystal panel including: a liquid crystal cell; and the polarizing plate arranged on one side, or each of both sides, of the liquid crystal cell. The organic EL device includes an organic EL panel including the polarizing plate arranged on a viewer side. The polarizing plate is typically arranged so that the transparent portion of the polarizer may correspond to the camera portion of an image display apparatus on which the polarizing plate is mounted.

Now, the present invention is specifically described by way of Examples. However, the present invention is not limited to these Examples. Methods of measuring respective characteristics are as described below.

### 1. Thickness

Measurement was performed with a digital micrometer (manufactured by Anritsu Corporation, product name: “KC-351C”).

### 2. Optical Characteristics

The single axis transmittance (Ts), parallel transmittance (Tp), and cross transmittance (Tc) of a polarizer were measured with a UV-visible spectrophotometer (manufactured by JASCO Corporation, product name: “V-7100”), and its polarization degree (P) was determined from the equation as indicated below. The Ts, the Tp, and the Tc are Y values measured with the two-degree field of view (C light source) of JIS Z 8701 and subjected to visibility correction.

Polarization degree(P)(%)={(Tp−Tc)/(Tp+Tc)})^{1/2}×100

### Example 1

### Production of Laminate

An amorphous isophthalic acid-copolymerized polyethylene terephthalate (IPA-copolymerized PET) film having an elongated shape and having a coefficient of water absorption of 0.75% and a Tg of 75° C. (thickness: 100 μm) was used as a resin substrate.

One surface of the resin substrate was subjected to a corona treatment. An aqueous solution containing polyvinyl alcohol (polymerization degree: 4,200, saponification degree: 99.2 mol %) and acetoacetyl-modified PVA (polymerization degree: 1,200, acetoacetyl modification degree: 4.6%, saponification degree: 99.0 mol % or more, manufactured by The Nippon Synthetic Chemical Industry Co., Ltd., trade name: “GOHSEFIMER Z-200”) at a ratio of 9:1 was applied to the corona-treated surface at 25° C. and dried to form a PVA-based resin layer having a thickness of 12 μm. Thus, a laminate was produced.

### (Production of Polarizing Plate)

The resultant laminate was subjected to free-end uniaxial stretching at a stretching ratio of 2.0 times in its longitudinal direction (lengthwise direction) between rolls having different peripheral speeds in an oven at 140° C. (in-air auxiliary stretching).

Next, the laminate was immersed in an in solubilizing bath having a liquid temperature of 30° C. (aqueous solution of boric acid obtained by compounding 100 parts by weight of water with 4 parts by weight of boric acid) for 30 seconds (in solubilizing treatment).

Next, the laminate was immersed in a dyeing bath having a liquid temperature of 30° C. while an iodine concentration and an immersion time were adjusted so that a polarizing plate to be obtained had a predetermined transmittance. In this example, the laminate was immersed in an aqueous solution of iodine obtained by compounding 100 parts by weight of water with 0.3 part by weight of iodine and 2.0 parts by weight of potassium iodide for 60 seconds (dyeing treatment).

Next, the laminate was immersed in a cross-linking bath having a liquid temperature of 30° C. (aqueous solution of boric acid obtained by compounding 100 parts by weight of water with 3 parts by weight of potassium iodide and 3 parts by weight of boric acid) for 30 seconds (cross-linking treatment).

After that, the laminate was subjected to uniaxial stretching so as to achieve a total stretching ratio of 5.5 times in the longitudinal direction (lengthwise direction) between rolls having different peripheral speeds while being immersed in an aqueous solution of boric acid having a liquid temperature of 70° C. (aqueous solution obtained by compounding 100 parts by weight of water with 4 parts by weight of boric acid and 5 parts by weight of potassium iodide) (underwater stretching).

After that, the laminate was immersed in a washing bath having a liquid temperature of 30° C. (aqueous solution obtained by compounding 100 parts by weight of water with 4 parts by weight of potassium iodide) (washing treatment).

After the washing, an aqueous solution of a PVA-based resin (manufactured by The Nippon Synthetic Chemical Industry Co., Ltd., trade name: “GOHSEFIMER (trademark) Z-200”, resin concentration: 3 wt %) was applied onto a PVA-based resin layer surface of the laminate, a triacetyl cellulose film (manufactured by Konica Minolta, Inc., trade name: “KC4UY”, thickness: 40 μm) was bonded thereto, and the resultant was heated in an oven maintained at 60° C. for 5 minutes. Thus, a polarizing plate including a polarizer having a thickness of 5 μm (single axis transmittance: 41.0%, polarization degree: 99.998%) was produced.

### (Formation of Transparent Portion)

The resin substrate was peeled from the resultant polarizing plate, a surface protective film having formed therein a circular through-hole having a diameter of 20 mm was bonded to the peeled surface (polarizer surface), and the resultant was immersed in a 1 mol/L (1 N, 4 wt %) aqueous solution of sodium hydroxide for 10 seconds (alkali treatment). After that, the resultant was dried at 60° C. and the surface protective film was peeled. Thus, a polarizing plate having a transparent portion was obtained. A PET film (thickness: 38 μm, manufactured by Mitsubishi Plastics, Inc., trade name: DIAFOIL) having formed thereon a pressure-sensitive adhesive layer having a thickness of 5 μm was used as the surface protective film.

### Example 2

A polarizing plate having a transparent portion was obtained in the same manner as in Example 1 except that immersion in 0.1 N hydrochloric acid for 30 seconds (acid treatment) was performed after the alkali treatment.

### Example 3

### Production of Polarizing Plate

A PVA film having a thickness of 75 μm (manufactured by Kuraray Co., Ltd., VF-PE #6000) was stretched at a stretching ratio of 2.0 times while being immersed in an aqueous solution at 30° C. for 30 seconds (swelling treatment).

Next, the PVA film was stretched at a stretching ratio of up to 3.0 times while the PVA film was immersed in a dyeing bath having a liquid temperature of 30° C. (dyeing treatment). In the dyeing treatment, an iodine concentration and an immersion time were adjusted so that a polarizing plate to be obtained had a predetermined transmittance. In this example, the film was dyed by being immersed in an aqueous solution of iodine obtained by compounding 100 parts by weight of water with 0.05 part by weight of iodine and 0.3 part by weight of potassium iodide for 60 seconds.

Next, the PVA film was immersed in a cross-linking bath having a liquid temperature of 30° C. (aqueous solution of boric acid obtained by compounding 100 parts by weight of water with 3 parts by weight of potassium iodide and 3 parts by weight of boric acid) for 30 seconds (cross-linking treatment).

After that, the PVA film was uniaxially stretched in its longitudinal direction (lengthwise direction) between rolls having different peripheral speeds so that a total stretching ratio became 5.5 times while being immersed in an aqueous solution of boric acid having a liquid temperature of 60° C. (aqueous solution obtained by compounding 100 parts by weight of water with 4 parts by weight of boric acid and 5 parts by weight of potassium iodide) (underwater stretching).

After that, the PVA film was immersed in a washing bath having a liquid temperature of 30° C. (aqueous solution obtained by compounding 100 parts by weight of water with 4 parts by weight of potassium iodide) (washing treatment).

After the washing, an aqueous solution of a PVA-based resin (manufactured by The Nippon Synthetic Chemical Industry Co., Ltd., trade name: “GOHSEFIMER (trademark) Z-200”, resin concentration: 3 wt %) was applied to one surface of the PVA film, a triacetylcellulose film (manufactured by Konica Minolta, Inc., trade name: “KC4UY”, thickness: 40 μm) was bonded thereto, and the resultant was heated in an oven maintained at 60° C. for 5 minutes. Thus, a polarizing plate including a polarizer having a thickness of 23 μm (single axis transmittance: 42.0%, polarization degree: 99.995%) was produced.

### (Formation of Transparent Portion)

The above-described surface protective film was bonded to the polarizer surface of the resultant polarizing plate, and the resultant was immersed in a 1 mol/L (1 N) aqueous solution of sodium hydroxide for 60 seconds. Next, the resultant was immersed in 0.1 N hydrochloric acid for 30 seconds. After that, the resultant was dried at 60° C. and the surface protective film was peeled. Thus, a polarizing plate having a transparent portion was obtained.

### Comparative Example 1

A polarizing plate obtained in the same manner as in Example 1 was irradiated with laser light (wavelength: 532 nm) from the protective film side by using a solid laser (YAG). Conditions for the irradiation with the laser light were as follows: a pulse energy of 40 μJ, a scanning speed of 100 mm/sec, and a pulse repetition rate of 3,120 Hz. Thus, a circular transparent portion having a diameter of 20 mm was formed in the polarizing plate.

### Comparative Example 2

A polarizing plate having a transparent portion was obtained in the same manner as in Comparative Example 1 except that a polarizing plate obtained in the same manner as in Example 3 was used.

### Comparative Example 3

### Production of Polarizing Plate

A laminate obtained in the same manner as in Example 1 was stretched at a stretching ratio of up to 5.0 times by free-enduniaxial stretching under heating at 110° C. The thickness of the PVA-based resin layer after the stretching treatment was 4 μm (in-air stretching).

Next, a circular anti-dyeing layer having a diameter of 20 mm was formed on the PVA-based resin layer surface of the laminate. Here, a PET film having formed thereon a pressure-sensitive adhesive layer having a thickness of 5 μm (thickness: 38 μm, manufactured by Mitsubishi Plastics, Inc., trade name: DIAFOIL) was used as the anti-dyeing layer.

Next, the laminate was immersed in a dyeing bath having a liquid temperature of 30° C. (an aqueous solution of iodine obtained by compounding 100 parts by weight of water with 0.5 part by weight of iodine and 3.5 parts by weight of potassium iodide) for 60 seconds (dyeing treatment).

Next, the laminate was immersed in a cross-linking bath having a liquid temperature of 60° C. (an aqueous solution of boric acid obtained by compounding 100 parts by weight of water with 5 parts by weight of potassium iodide and 5 parts by weight of boric acid) for 60 seconds (cross-linking treatment).

After that, the laminate was immersed in a washing bath (an aqueous solution obtained by compounding 100 parts by weight of water with 3 parts by weight of potassium iodide) (washing treatment).

After the washing, a PVA-based resin aqueous solution (manufactured by The Nippon Synthetic Chemical Industry Co., Ltd., trade name: “GOHSEFIMER (trademark) Z-200”, resin concentration: 3 wt %) was applied to the PVA-based resin layer surface of the laminate, and a triacetylcellulose film (manufactured by Konica Minolta, Inc., trade name: “KC4UY”, thickness: 40 μm) was bonded thereto, followed by the heating of the resultant in an oven maintained at 60° C. for 5 minutes. After that, the resin substrate was peeled. Thus, a polarizing plate having a transparent portion (single axis transmittance: 42.0%, polarization degree: 99.8%) was produced.

The resultant polarizing plates were each subjected to the following evaluations. The evaluation results are shown in Table 1.

### 1. Iodine Content of Polarizer

The iodine content of a polarizer before the formation of a transparent portion and the iodine content of the transparent portion were measured. Specifically, the content of each element was determined from a calibration curve created in advance from the X-ray intensity of the element measured by fluorescent X-ray analysis under the following conditions through the use of a standard sample.
Analysis apparatus: manufactured by Rigaku Corporation, X-ray fluorescence (XRF) analysis apparatus, product name “ZSX100e”
Anticathode: rhodium
Dispersive crystal: lithium fluoride
Excitation light energy: 40 kV-90 mA
Iodine measured line: I-LA
Quantification method: FP method
2θ angle peak: 103.078 deg (iodine)
Measurement time: 40 seconds

### 2. Transmittance and Hue of Transparent Portion

The transmittance and hue (single a value and single b value) of a transparent portion were measured with a UV-visible spectrophotometer (manufactured by JASCO Corporation, product name: “V-7100”).

TABLE 1

| | | | | Transparent portion | | | | | |
|---|---|---|---|---|---|---|---|---|---|
| | Formation of | | | Iodine (wt %) | | | | | |
| | transparent | | Thickness | Before | After | Transmittance | a | b | |
| | portion | Stretching | (μm) | decolorization | decolorization | (%) | value | value | (a² + b²)^{1/2} |
| Example 1 | Alkali | In-air + | 5 | 8 | <0.1 | 91 | −0.11 | 0.43 | 0.45 |
| | treatment | underwater | | | | | | | |
| Example 2 | Alkali | In-air + | 5 | 8 | <0.1 | 91 | −0.10 | 0.42 | 0.43 |
| | treatment | underwater | | | | | | | |
| Example 3 | Alkali | Underwater | 23 | 4 | <0.1 | 91 | −0.10 | 0.50 | 0.51 |
| | treatment | | | | | | | | |
| Comparative | Laser light | In-air + | 5 | 8 | 8 | 88 | −2.0 | 5.5 | 5.8 |
| Example 1 | irradiation | underwater | | | | | | | |
| Comparative | Laser light | Underwater | 23 | 4 | 4 | 80 | −4.1 | 14.2 | 14.8 |
| Example 2 | irradiation | | | | | | | | |
| Comparative | Formation of | In-air | 4 | — | <0.1 | 91 | −0.5 | 1.02 | 1.14 |
| Example 3 | anti-dyeing | | | | | | | | |
| | layer | | | | | | | | |

In each of Examples, the hue of the transparent portion is extremely close to a neutral color irrespective of the thickness of the polarizer. In contrast, in each of Comparative Examples 1 and 2, the hue (that is yellowish) of the transparent portion is at such a level as to be capable of being clearly observed with the eyes, and in Comparative Example 3, the absolute values of both the a value and the b value are higher than those of the respective examples despite the fact that the thickness is small.

In a method including arranging an anti-dyeing layer on a resin film, and then dyeing the resultant with a dichromatic substance like Comparative Example 3, for example, in order that the shape of a transparent portion to be formed may be precisely controlled, it is important that a stretching treatment be completed before the dyeing of the resin film. When the stretching is completed before the dyeing as described above, the alignment of the dichromatic substance becomes relatively low, and hence it becomes difficult to achieve high optical characteristics. In addition, when the stretching is performed after the formation of the anti-dyeing layer, the anti-dyeing layer peels at the time of the stretching. A polarizer is industrially produced by subjecting a resin film having an elongated shape to various treatments, such as dyeing, but it is practically difficult to arrange the anti-dyeing layer at a position spaced apart from an end side of the resin film to form the transparent portion (e.g., to form a circular transparent portion at the center of the film). Specifically, the anti-dyeing layer is preferably removed after the dyeing, and a pressure-sensitive adhesive film having an elongated shape is industrially used as the anti-dyeing layer. However, it is difficult to arrange the pressure-sensitive adhesive film having an elongated shape so that the film may be spaced apart from the end side of the resin film.

Examples 1 and 2 were each also evaluated for the following item.

### (Sodium Content)

A sodium content in the transparent portion of a polarizer was determined by fluorescent X-ray analysis. Specifically, the sodium content of the polarizer was determined from a calibration curve produced in advance from an X-ray intensity measured under the following conditions through the use of a standard sample.
Analysis apparatus: manufactured by Rigaku Corporation, X-ray fluorescence (XRF) analysis apparatus, product name “ZSX100e”
Anticathode: rhodium
Dispersive crystal: lithium fluoride
Excitation light energy: 40 kV-90 mA
Sodium measured line: Na-KA
Quantification method: FP method
Measurement time: 40 seconds

While the sodium content of the transparent portion of Example 1 was 4.0 wt %, the sodium content of the transparent portion of Example 2 was 0.04 wt %.

The polarizer of the present invention is suitably used in an image display apparatus (a liquid crystal display apparatus or an organic EL device) with a camera of, for example, a cellular phone, such as a smart phone, a notebook PC, or a tablet PC.

Many other modifications will be apparent to and be readily practiced by those skilled in the art without departing from the scope and spirit of the invention. It should therefore be understood that the scope of the appended claims is not intended to be limited by the details of the description but should rather be broadly construed.

What is claimed is:

1. A polarizer, comprising a resin film containing iodine, wherein the polarizer has formed therein a transparent portion having a transmittance higher than that of another portion, and the transparent portion has a single hue (a²+b²)^{1/2} of less than 1.0, where the a represents an a value of an Lab colorimetric system and the b represents a b value of the Lab colorimetric system.

2. The polarizer according to claim 1, wherein the transparent portion has an iodine content of 1.0 wt % or less.

3. The polarizer according to claim 1, wherein the transparent portion has a content of at least one of an alkali metal and an alkaline earth metal of 0.5 wt % or less.

4. The polarizer according to claim 1, wherein the resin film has a thickness of 8 μm or less.

5. The polarizer according to claim 1, wherein optical characteristics in the another portion satisfy relationships of P>-(10^{0.929T-42.4}−1)×100, provided that T<42.3, and P≧99.9, provided that T≧42.3, where P represents a polarization degree (%) and T represents a single axis transmittance (%).

6. The polarizer according to claim 1, wherein the transparent portion corresponds to a camera portion of an image display apparatus on which the polarizer is mounted.

7. A method of producing the polarizer of claim 1, the method comprising decolorizing a desired portion of a resin film containing a dichromatic substance.

8. The production method according to claim 7, wherein the decolorizing is performed by bringing a basic solution into contact with the resin film containing the dichromatic substance.

9. The production method according to claim 8, further comprising bringing an acidic solution into contact with a portion of the resin film with which the basic solution has been brought into contact.

10. The production method according to claim 8, wherein at a time of the contact of the basic solution, a surface of the resin film is covered with a surface protective film so that at least part of the surface of the resin film may be exposed.

11. The production method according to claim 7, wherein the resin film containing the dichromatic substance is produced by a method including dyeing a resin film with the dichromatic substance, and subjecting the resin film to underwater stretching.

12. A polarizing plate, comprising the polarizer having formed therein the transparent portion of claim 1.

13. The polarizing plate according to claim 12, wherein the polarizing plate has a shape corresponding to an image display apparatus on which the polarizing plate is mounted, and the transparent portion is formed to be spaced apart from an end side.

14. An image display apparatus, comprising the polarizing plate of claim 12.
